(19) United States
(12) Patent Application Publication
(10) Pub. No.: US 2006/0271872 A1
(43) Pub. Date: Nov. 30, 2006

(54) Folder icon display control apparatus, method and program

(75) Inventor: Yuuki Shirai, Asaka-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Fuji Photo Film Co., Ltd., Minami-Ashigara-shi (JP)

(21) Appl. No.: 11/439,177

(22) Filed: May 24, 2006

(30) Foreign Application Priority Data
May 25, 2005 (JP) 2005-151721

(51) Int. Cl. G06F 9/00

(52) U.S. Cl. 715/764; 715/810; 715/835; 715/834

(57) ABSTRACT

The latest generated folder among folders that have been stored on a hard disk is adopted as a present folder and an icon representing this present folder is displayed at the approximate center of a display screen. A folder that was generated before the present folder is adopted as a past folder and an icon representing this past folder is displayed on the left side of the icon of the present folder. A future folder is generated and is displayed on the right side of the icon of the present folder. Since the icon of the future folder is displayed, the display screen can be utilized in well-balanced and effective fashion.

### BACKGROUND OF THE INVENTION

1. Field of the Invention

This invention relates to an apparatus, method and program for controlling the display of folder icons.

2. Description of the Related Art

As appliances and portable terminal devices have come to incorporate the features of personal computers, these appliances and portable terminal devices are now capable of handling multiple items of data and of possessing multiple functions. For this reason, such appliances and portable terminal devices require a convenient and simple GUI (Graphical User Interface). In one example of such a GUI, operation in the horizontal direction is an operation that selects a function while operation in the vertical direction is an operation that selects content (see the specification of Japanese Patent Application Laid-Open No. 2004-356774). There is also prior art that simplifies the operation of selecting content (see the specification of Japanese Patent Application Laid-Open No. 2001-312350).

In either case, however, the efficiency of display screen utilization is not necessarily high and portions that are unnecessary appear on the display screens. It is necessary to improve the efficiency of display screen utilization particularly in appliances and portable terminal devices that have a small display screen.

### SUMMARY OF THE INVENTION

Accordingly, an object of the present invention is to raise the efficiency of display screen utilization.

According to the present invention, the foregoing object is attained by providing an apparatus for controlling display of folder icons, comprising: a present-folder retrieving device for finding a present folder generated last in a file storage device in response to application of a folder display command; a present-folder-icon display control device for controlling a display unit in such a manner that an icon of the present folder found by the present-folder retrieving device is displayed on a display screen; a past-folder retrieving device for finding a past folder, which was generated before the present folder found by the present-folder retrieving means, in the file storage device; a future-folder generating device for generating a future folder in response to finding of the present folder by the present-folder retrieving means; and a past/future-folder-icon display control device for controlling the display unit in such a manner that an icon of the past folder found by the past-folder retrieving device and an icon of the future folder are displayed so as to bracket the icon of the present folder on opposite sides thereof.

The present invention also provides a control method suited to the above-described folder icon display control apparatus. More specifically, the invention provides a method of controlling display of folder icons, comprising the steps of: finding a present folder generated last in a file storage device in response to application of a folder display command; controlling a display unit in such a manner that an icon of the found present folder is displayed on a display screen; finding a past folder, which was generated before the found present folder, in the file storage device; generating a future folder in response to finding of the present folder; and controlling the display unit in such a manner that an icon of the found past folder and an icon of the future folder are displayed so as to bracket the icon of the present folder on opposite sides thereof.

The present invention also provides a program suited to the folder icon display control apparatus.

In accordance with the present invention, a present file generated last is found in a file storage device in response to application of folder display command. The icon of the found present folder is displayed on the display screen of a display unit. Further, a past folder that was generated before the present folder is found. The icon of the found past folder and the icon of the generated future folder are displayed so as to bracket the icon of the present folder on opposite sides. Since the icon of the future folder is generated and the icon of the present folder is displayed in a form bracketed by the icon of the generated future folder and the icon of the past folder, the icon of the present folder will not appear at the edge of the screen. Since the future folder also is displayed and not only the past and present folders, the display screen can be used comparatively efficiently.

The past/future-folder-icon display control device preferably controls the display unit in such a manner that the latest folder icon is displayed at a central portion of the display screen. Since the present folder, which is the folder most likely to be utilized, is displayed substantially at the central portion of the display screen, the folder becomes easier to use.

The present-folder retrieving device may find as present folders, in response to application of the folder display command, a plurality of folders, inclusive of a latest folder generated last, in order of decreasing recentness in terms of the order in which they were generated. In this case the past-folder retrieving device would find a plurality of past folders that were generated before the plurality of folders found by the present-folder retrieving device. Further, the future-folder generating device would generate a plurality of future folders, and the present-folder-icon display control device would control the display unit in such a manner that the present folders found by the present-folder retrieving device are displayed on the circumference of the same circle. The past/future-folder-icon display control device would control the display unit so as to display the plurality of past folders, which have been found by the past-folder retrieving device, inside or outside the plurality of present folders displayed on the circumference of the same circle, and display the plurality of future folders, which have been generated by the future-folder retrieving device, outside or inside the plurality of present folders displayed on the circumference of the same circle.

In a case where the past folder, present folder and future folder are image folders each containing image files, the apparatus may further comprise a human-figure extracting device for extracting a human figure from an image displayed by an image file contained in the present folder; a composite image file generating device for generating a composite image file by combining the human figure extracted by the human-figure extracting device and a template image; and a storage device for storing the composite image, which has been generated by the composite image file generating device, in the future folder generated by the future-folder generating device. Since the composite image file is stored in the future folder, a user can enjoy viewing unanticipated images.

In a case where the past folder, present folder and future folder are music folders each containing music files, the apparatus may further comprise a sample music requesting device for sending a music server a transmit request for requesting transmission of a sample music file; a sample music file receiving device for receiving a sample music file transmitted from the music server in response to the transmit request from the sample music request device; and a storage device for storing the sample music file, which has been received by the sample music file receiving device, in the future folder. Since the sample music file is stored in the future folder, a sample music can be heard.

The apparatus may further comprise a music file storage device for storing a music file; a similar-music deciding device for deciding music that is similar to music (music of the same artist or music of the same genre) that is output by the music file stored in the music file storage device; a similar-music related-data transmitting device for sending a music server a transmit request for requesting transmission of data relating to the similar music decided by the similar-music deciding device; a similar-music related-data receiving device for receiving data relating to the similar music (jacket image data, sample music data, promotional music data) transmitted from the music server in response to the transmit request transmitted from the similar-music related-data transmitting device; and a storage device for storing the data relating to similar music, which has been received by the similar-music related-data receiving device, in the future folder. Since data relating to similar music is stored in the future folder, an entrepreneur in the music business can perform promotional activities.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical structure of a hard-disk recorder;

FIG. 2 is a flowchart illustrating processing for displaying folder icons;

FIGS. 3 and 4 illustrate examples of displays of folder icons;

FIG. 5 is a flowchart illustrating other processing of folder icons;

FIG. 6 is a diagram illustrating an example of display folder icons;

FIG. 7 is a flowchart illustrating processing for generating a composite image;

FIG. 8A illustrates an example of an image containing a human figure, and FIG. 8B illustrates an example of the extracted human figure;

FIG. 9A illustrates an example of a template image, and FIG. 9B illustrates an example of a composite image;

FIG. 10 illustrates an overview of a network system; and

FIG. 11 illustrates processing executed by a hard-disk recorder and by a promotional-music distributing server.

### DESCRIPTION OF THE PREFERRED EMBODIMENT

A preferred embodiment of the present invention will now be described with reference to the drawings.

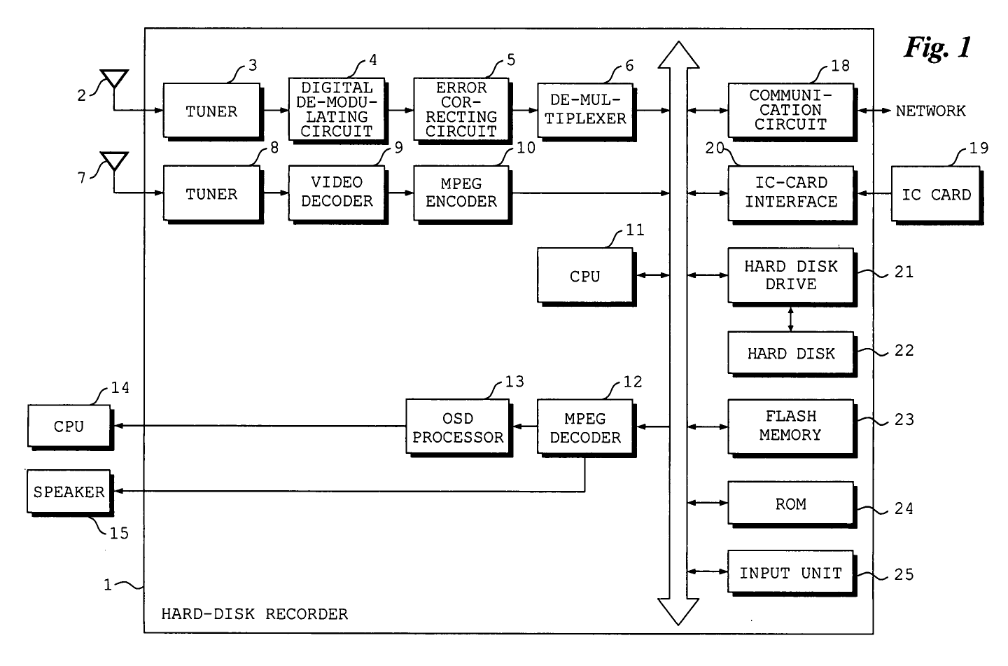

FIG. 1 illustrates the electrical structure of a hard-disk recorder 1 embodying the present invention.

The operation of the overall hard-disk recorder 1 is controlled by a CPU 11.

The hard-disk recorder 1 includes a ROM 24 storing a program for performing an operation described below. The hard-disk recorder 1 is provided with an input unit 25 and operates based upon an input signal applied thereto by the input unit 25.

The hard-disk recorder 1 is provided with a satellite antenna 2 and is capable of receiving a satellite broadcast. Satellite broadcast data of a desired channel is extracted by a tuner 3 from the satellite broadcast received by the satellite antenna 2. The satellite broadcast data is digitally demodulated in a digital demodulating circuit 4 and the demodulated signal is subjected to error correction processing in an error correcting circuit 5. The error-corrected satellite broadcast data is applied to a display unit 14 via a demultiplexer 6, satellite broadcast data MPEG (Moving Picture Experts Group) decoder 12 and OSD (On-Screen Device) 13. The satellite broadcast is displayed on the display screen of the display unit 14. Further, an audio signal is output from the MPEG decoder 12 and applied to a speaker 15, whereby audio is output.

The hard-disk recorder 1 is further provided with a ground-wave antenna 7 which can receive a ground-wave broadcast signal. The ground-wave broadcast signal of a desired channel is extracted by a tuner 8 from a ground-wave TV broadcast signal received by the ground-wave antenna 7. The ground-wave broadcast signal is subjected to decode processing by a video decoder 9 and is encoded in an MPEG encoder 10. The encoded ground-wave broadcast signal is applied to the display unit 14 via the MPEG decoder 12 and OSD processing circuit 13, whereby the ground-wave broadcast is displayed on the display screen of the display unit 14.

The hard-disk recorder 1 is further provided with a communication circuit 18. Various files such as an image (still-picture) file, moving-picture file and music file are input to the communication circuit 18 via a network. The hard-disk recorder 1 is further provided with an IC-card interface 20 that enables the input of files that have been stored on an IC card 19. A file that has been input to the hard-disk recorder 1 is stored temporarily in a flash memory 23. By reading the file output of the flash memory 23, the file is recorded on a hard disk 22 using a hard-disk drive 21.

The hard-disk recorder 1 is capable of storing files in a folder in the same way as a personal computer. The folder is generated in response to a command from the input unit 25. The generated folder contains the various files mentioned above.

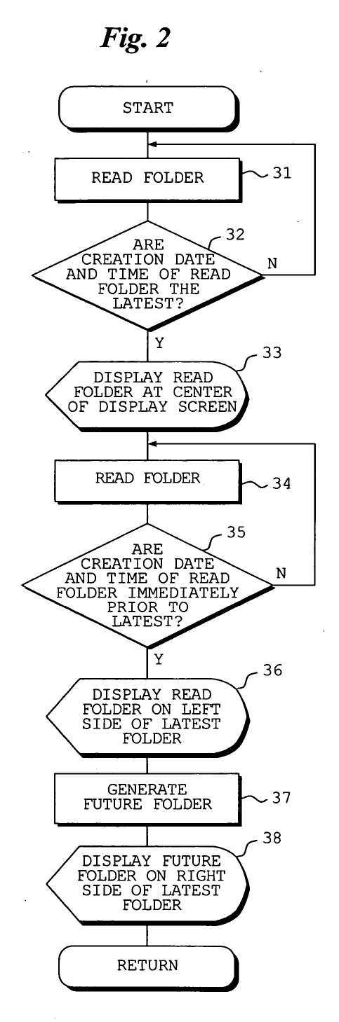

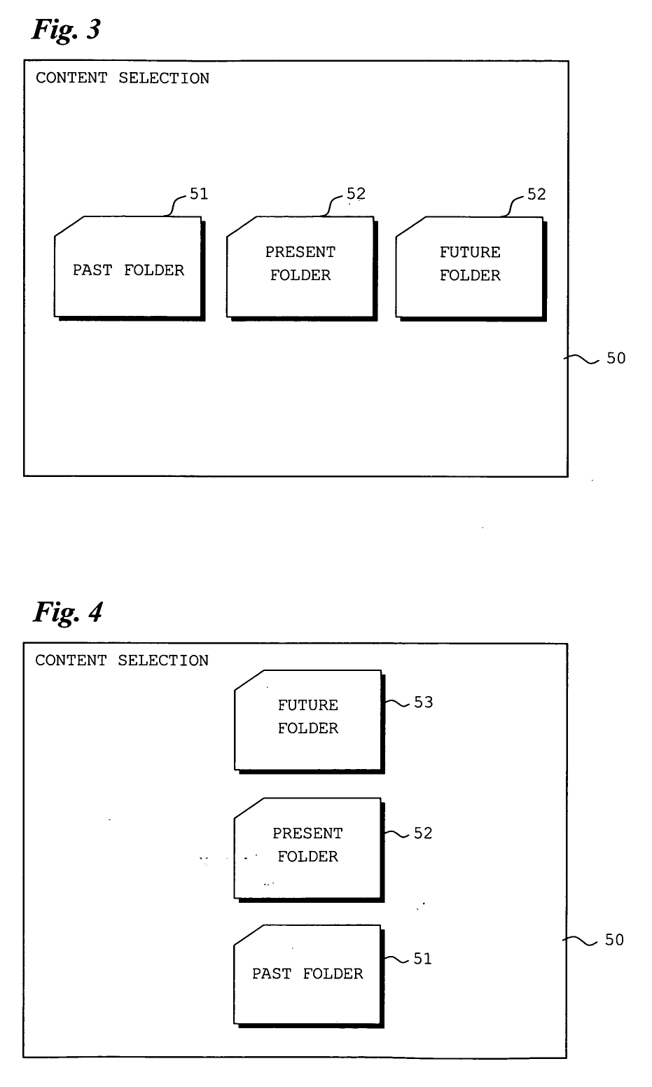

FIG. 2 is a flowchart illustrating processing for displaying folder icons. Display of folders starts in response to a selection command, which is for selecting content (a file) that has been recorded on the hard disk 22, that enters from the input unit 25. FIG. 3 illustrates an example of icons displayed on the display screen of the display unit 14.

As illustrated in FIG. 3, this processing displays an icon 52 of the latest folder (a present folder), namely the folder that was generated last, substantially at the central portion of a display screen 50 of the display unit 14, displays an icon 51 of a folder (a past folder), which was generated before the present folder, on the left side of the icon 52, and displays a folder 53, which is referred to as a “future folder”, on the right side of the present folder 52. Since the icon 53 of the future folder is displayed on the right side of the folder 52 of the present folder even in a case where the icon 52 of the present folder is displayed at the center, the display screen 50 can be utilized more efficiently in comparison with a case there the icon 53 of the future folder is not displayed. In addition, the overall display balance is improved.

A folder that has been recorded on the hard disk 22 is read (step 31) and whether the creation date and time of the read folder indicate that this is the latest folder is checked at step 32. The creation dates and times of all folders recorded on the hard disk 22 are verified so that it can be confirmed whether the creation date and time of the read folder indicate that this is the latest folder. Of course, the latest folder may be read after the creation dates and times of all folders recorded on the hard disk 22 have been verified. In any case, if the read folder is the latest (“YES” at step 32), this folder is adopted as the latest present file and the icon 52 of the present folder is displayed substantially at the central portion of the display screen 50 (step 33).

A folder is read from the hard disk 22 again (step 34) and whether the creation date and time of the read folder indicate that this folder was generated immediately before the latest present folder is checked in a manner similar to that described above (step 35). If a folder that was generated immediately before the latest folder is read (“YES” at step 35), then the icon of the read folder is displayed as the icon of a past folder on the left side of the icon 52 of the present folder (step 36).

Next, a future folder is generated (step 37), whereupon the icon 53 of the future folder is displayed on the right side of the present folder 52 (step 38).

Thus, the icon 52 of the present folder is displayed at the approximate center of the display screen 50, the icon 51 of the past folder is displayed on the left side of the icon 52 of the present folder, and the icon 53 of the future folder is displayed on the right side of the icon 52 of the present folder. The display screen 50 can be utilized effectively and with good balance by generating the future folder. Of course, it may be so arranged that the icon 51 of the past folder is displayed on the right side of the icon 52 of the present folder and the icon 53 of the future folder is displayed on the left side of the icon 52 of the present folder. It may be so arranged that icons of a plurality of past folder or icons of a plurality of future folders are displayed on the left side or right side of the icon 52 of the present folder.

It may be so arranged that a list of generated folders is displayed and the list is updated whenever a folder is generated. By referring to the list of generated folders, present and past folders can be found in simple fashion.

FIG. 4 illustrates another example of icons displayed on the display screen 50.

Here the icon 52 of the present folder is being displayed at the approximate center of the display screen 50 in the manner described above. The icon 51 of the past folder is being displayed below the icon 52. Further, the icon 53 of the future folder is being displayed above the icon 52 of the present folder. Thus, it may be so arranged that the icon 51 of the past folder is displayed below the icon 52 of the present folder and the icon 53 of the future folder is displayed above the icon 52 of the present folder. Conversely, it may be so arranged that the icon 51 of the past folder is displayed above the icon 52 of the present folder and the icon 53 of the future folder is displayed below the icon 52 of the present folder.

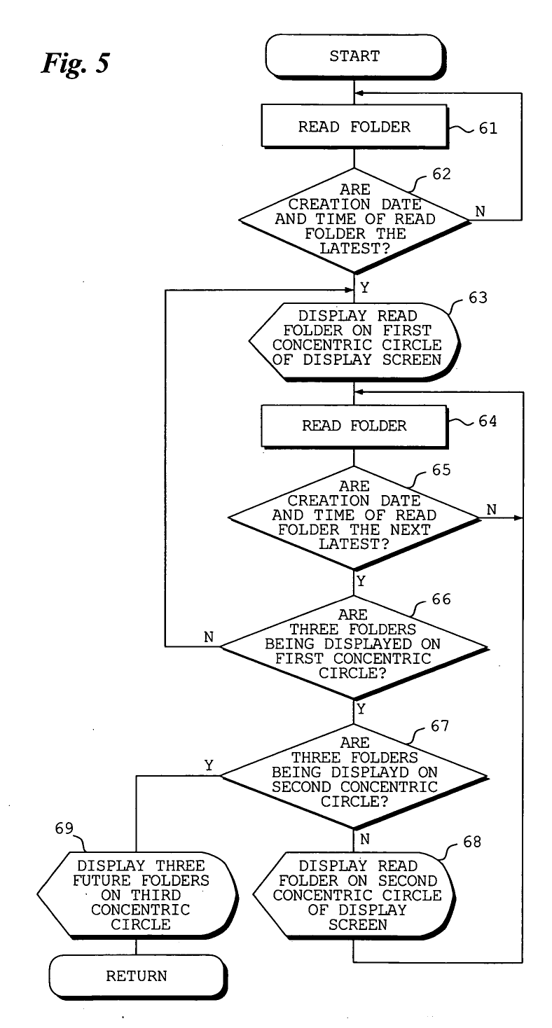

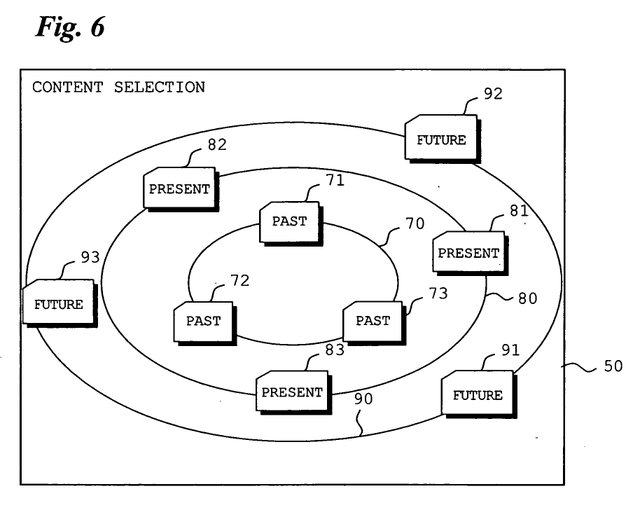

FIG. 5 is a flowchart illustrating other processing for displaying folder icons, and FIG. 6 illustrates an example of folder icons displayed on a display screen.

In this embodiment, three concentric circles 70, 80 and 90 are defined, as illustrated in FIG. 6. The concentric circles 70, 80 and 90 may or may not be displayed on the display screen 50. Among the three concentric circles, the concentric circle 80 located between the outermost concentric circle 90 and innermost concentric circle 70 is a first concentric circle, the innermost concentric circle 70 is a second concentric circle, and the outermost concentric circle 90 is a third concentric circle.

In this embodiment, icons 81, 82, 83 of present folders are displayed on the first concentric circle 80, icons 71, 72, 73 of past folders are displayed on the second concentric circle 70, and icons 91, 92, 93 of future folders are displayed on the third concentric circle 90. Of course, it may be arranged that the icons of the future folders are displayed on the second concentric circle 70, the icons of the present folders are displayed on the first concentric circle 80 and the icons of the past folders are displayed on the third concentric circle 90.

A folder is read from the hard disk 22 (step 61) and whether this is the latest folder is checked (step 62). If the folder is the latest folder (“YES” at step 62), then the icon of the read folder is displayed on the first concentric circle 80 (step 63). A folder is read again (step 64) and whether the read folder is the next latest is checked (step 65).

If the folder is not the next latest (“NO” at step 65), then a folder is read again. If this folder is the next latest folder (“YES” at step 65), then it is determined whether the number of icons of present folders being displayed on the first concentric circle 80 is already three (step 66). If the number being displayed is not yet three (“NO” at step 66), then the icon of the read folder is displayed on the first concentric circle 80 (step 63). If the icons of three present folders are already being displayed on the first concentric circle 80 (“YES” at step 66), then the read folder is a past folder. It is determined whether the icons of folders (past folders) being displayed on the second concentric circle 70 are already three in number (step 67). If the number being displayed is not yet three (“NO” at step 67), then the icon of the read folder is displayed as a past folder on the second concentric circle 70 (step 68). The processing of steps 64 to 68 is repeated until the icons of three past folders are displayed on the second concentric circle 70.

If the number of icons of past folders being displayed on the second concentric circle 70 is three (“YES” at step 67), then three icons of future folders are displayed on the third concentric circle 90 (step 69).

Thus, three icons 81, 82, 83 of present folders are displayed on the first concentric circle 80, three icons 71, 72, 73 of past folders are displayed on the second concentric circle 70, and three icons 91, 92, 93 of future folders are displayed on the third concentric circle 90. The user can utilize the display screen 50 effectively with this display method as well. Although three icons are displayed on each of the concentric circles 70, 80 and 90 in the embodiment described above, it may be so arranged that different numbers of icons are displayed.

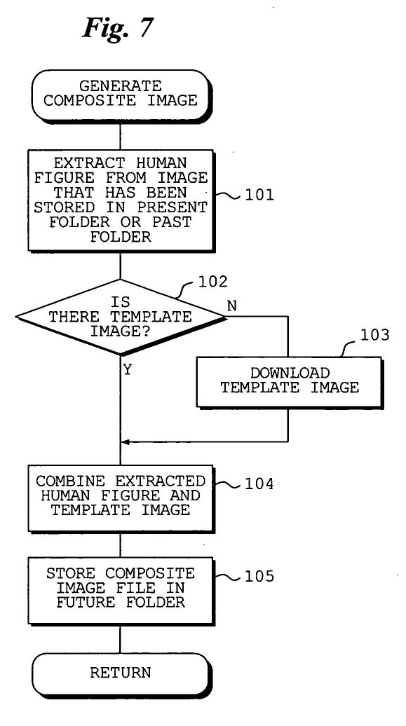

FIG. 7 to FIGS. 9A, 9B illustrate a modification. In this modification, a composite image file is stored in a future folder that has been generated in the manner described above.

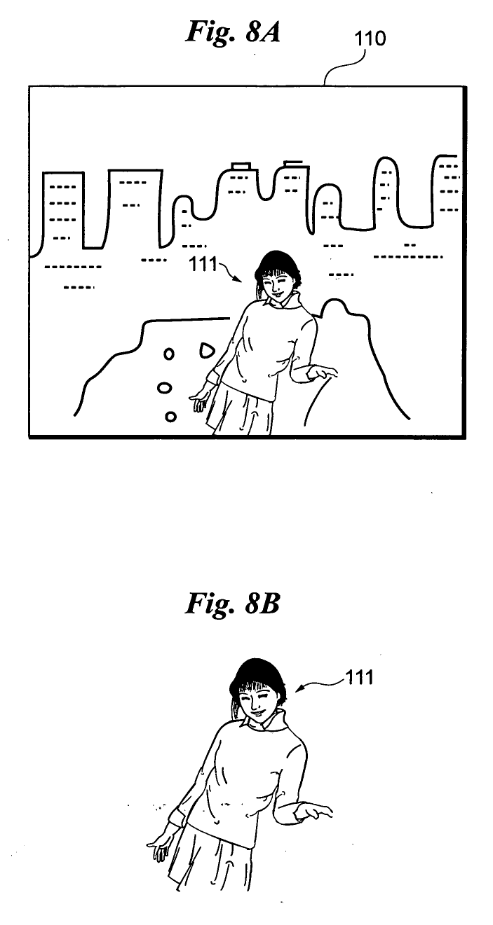

First, any image file (this may be the latest image file or another image file) that is contained in a present folder or past folder is found and a human figure is extracted from the image represented by this image file (step 101). For example, if an image 110 containing a human FIG. 111 is found, as illustrated in FIG. 8A, the human FIG. 111 is extracted from the image 110, as illustrated in FIG. 8B.

Next, it is determined whether a file representing a template image has been recorded on the hard disk 22 (step 102). If a template image file has not been recorded on the hard disk 22 (“NO” at step 102), then a template image file is downloaded from the image server (step 103).

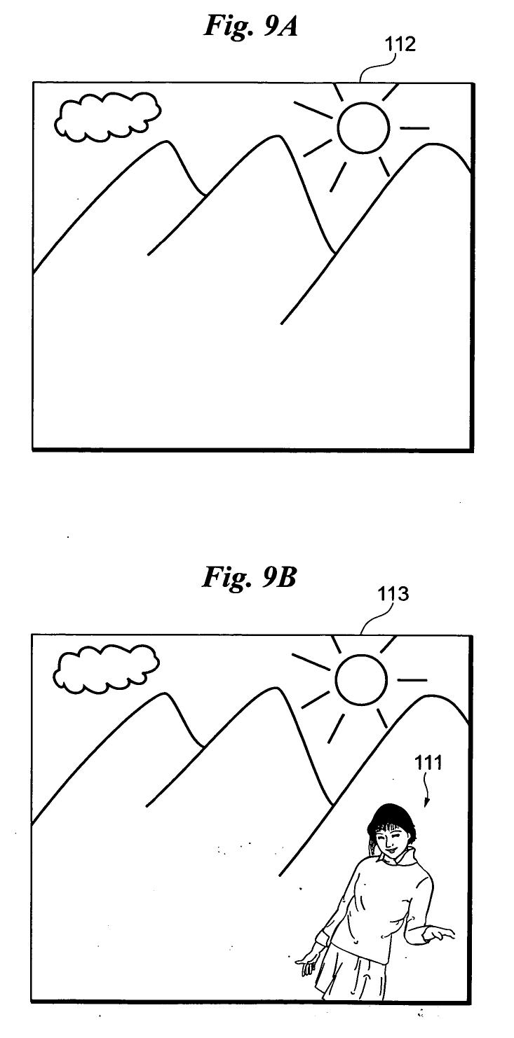

If a template image is obtained, the obtained template image and the extracted human figure are combined to generate a composite image (step 104). For example, if a template image 112 is obtained, as illustrated in FIG. 9A, then the template image 112 is combined with the human figure extracted as shown in FIG. 8B, whereby a composite image 113 is generated, as illustrated in FIG. 9B. The composite image file representing the composite image thus generated is stored in the above-mentioned future folder.

By storing the composite image file in the future folder, the icon of the composite image file will appear when the future folder is opened. Opening the composite image file will cause the composite image to be displayed on the display screen of the display unit 14. By using the image of a pleasure resort as the template image, an image in which the person represented by the extracted human figure appears to have gone to the resort will be displayed. This can be employed to encourage one to visit the resort.

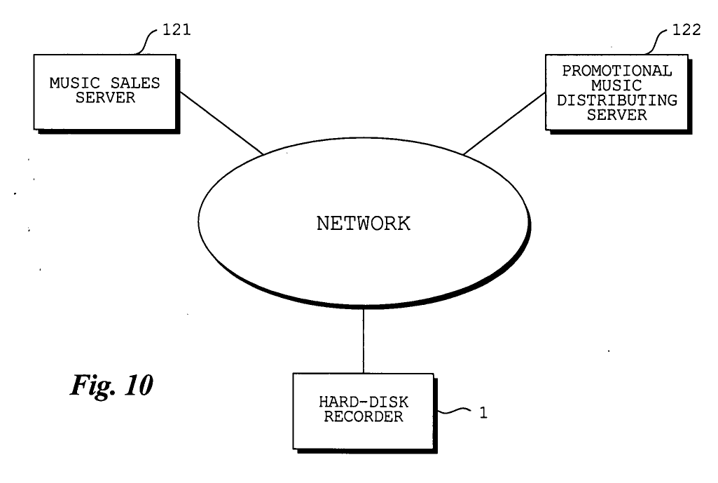

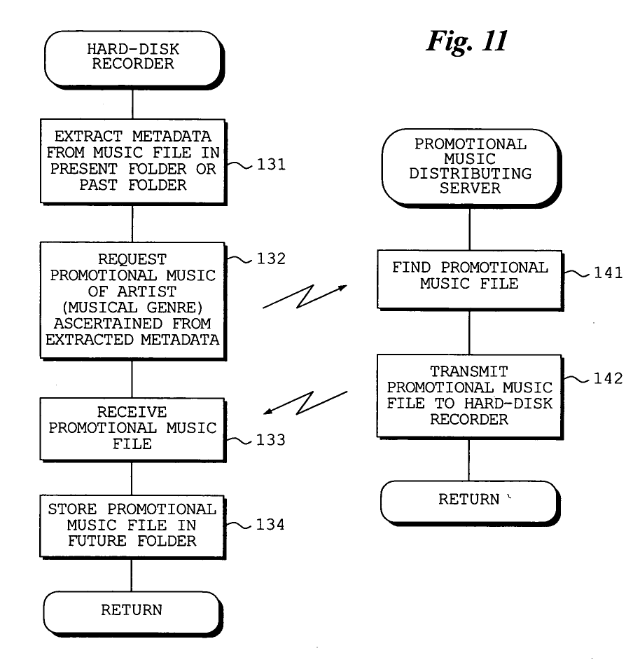

FIGS. 10 and 11 illustrate another modification. FIG. 10 illustrates an overview of a network system, and FIG. 11 is a flowchart illustrating processing executed by the network system.

This processing stores a promotional music file or the like in a future folder.

As shown in FIG. 10, the hard-disk recorder 1, a server 121 for music sales and a promotional music distributing server 122 are connected via a network.

A purchase request for purchasing a music file is transmitted from the hard-disk recorder 1 to the music sales server 121. When this is done, this music file is sold to the user of the hard-disk recorder 1 and the music file is transmitted from the music sales server 121 to the hard-disk recorder 1. The music file is received by the hard-disk recorder 1, whereby the music file is stored in a present folder in the manner described above.

With reference to FIG. 11, metadata is extracted from a music file that has been stored in a present folder or past folder in the manner described above (step 131). Since the artist (or genre) of the music in the music file can be ascertained from the extracted metadata, a request for promotional music of this artist is transmitted from the hard-disk recorder 1 to the promotional music distributing server 122 (step 132).

Upon receiving the request for promotional music from the hard-disk recorder 1, the promotional music distributing server 122 finds the promotional music of the artist (the musical genre) that conforms to the request (step 141). The file (sample music file) of the found promotional music is transmitted from the promotional music distributing server 122 to the hard-disk recorder 1 (step 142).

Upon receiving the promotional music file transmitted from the promotional music distributing server 122 (step 133), the hard-disk recorder 1 stores the received promotional music file in a future folder (step 134). By opening the future folder and then opening the promotional music file, the promotional music can be heard. This would make it possible for a musical entrepreneur to give notification of a music file that the user of the hard-disk recorder might be inclined to purchase in the future. It may be so arranged that a jacket image relating to a purchased music file or a file of the image of the artist is transmitted instead of a promotional music file.

It may be so arranged that a plurality of files are stored in a future folder in the above-described embodiment. Furthermore, it may be so arranged that in a case where a plurality of future folders are displayed, as illustrated in FIG. 6, an image of the near future, an image of the comparatively near future and an image of the distant future are generated from the human figure extracted as set forth above, and the image files of these images are stored in respective ones of the future folders.

As many apparently widely different embodiments of the present invention can be made without departing from the spirit and scope thereof, it is to be understood that the invention is not limited to the specific embodiments thereof except as defined in the appended claims.

What is claimed is:

1. An apparatus for controlling display of folder icons, comprising:
a present-folder retrieving device for finding a present folder generated last in a file storage device in response to application of a folder display command;
a present-folder-icon display control device for controlling a display unit in such a manner that an icon of the present folder found by the present-folder retrieving device is displayed on a display screen;
a past-folder retrieving device for finding a past folder, which was generated before the present folder found by said present-folder retrieving means, in the file storage device;
a future-folder generating device for generating a future folder in response to finding of the present folder by said present-folder retrieving means; and
a past/future-folder-icon display control device for controlling the display unit in such a manner that an icon of the past folder found by said past-folder retrieving device and an icon of the future folder are displayed so as to bracket the icon of the present folder on opposite sides thereof.

2. The apparatus according to claim 1, wherein said past/future-folder-icon display control device controls the display unit in such a manner that the latest folder icon is displayed at a central portion of the display screen.

3. The apparatus according to claim 1, wherein said present-folder retrieving device finds as present folders, in response to application of the folder display command, a plurality of folders, inclusive of the latest folder generated last, in order of decreasing recentness in terms of the order in which the folders were generated;
said the past-folder retrieving device finds a plurality of past folders that were generated before the plurality of folders found by said present-folder retrieving device;
said future-folder generating device generates a plurality of future folders;
said present-folder-icon display control device controls the display unit in such a manner that the present folders found by said present-folder retrieving device are displayed on the circumference of the same circle; and
said past/future-folder-icon display control device controls the display unit so as to display the plurality of past folders, which have been found by said past-folder retrieving device, inside or outside the plurality of present folders displayed on the circumference of the same circle, and display the plurality of future folders, which have been generated by said future-folder retrieving device, outside or inside the plurality of present folders displayed on the circumference of the same circle.

4. The apparatus according to claim 1, wherein the past folder, present folder and future folder are image folders each containing image files, and said apparatus further comprises:
a human-figure extracting device for extracting a human figure from an image displayed by an image file contained in the present folder;
a composite image file generating device for generating a composite image file by combining the human figure extracted by said human-figure extracting device and a template image; and
a storage device for storing the composite image, which has been generated by said composite image file generating device, in the future folder generated by said future-folder generating device.

5. The apparatus according to claim 1, wherein the past folder, present folder and future folder are music folders each containing music files, and said apparatus further comprises:
a sample music requesting device for sending a music server a transmit request for requesting transmission of a sample music file;
a sample music file receiving device for receiving a sample music file transmitted from the music server in response to the transmit request from said sample music request device; and
a storage device for storing the sample music file, which has been received by said sample music file receiving device, in the future folder.

6. The apparatus according to claim 1, further comprising:
a music file storage device for storing a music file;
a similar-music deciding device for deciding music that is similar to music that is output by the music file stored in said music file storage device;
a similar-music related-data transmitting device for sending a music server a transmit request for requesting transmission of data relating to the similar music decided by said similar-music deciding device;
a similar-music related-data receiving device for receiving data relating to the similar music transmitted from the music server in response to the transmit request transmitted from said similar-music related-data transmitting device; and
a storage device for storing the data relating to similar music, which has been received by said similar-music related-data receiving device, in the future folder.

7. A method of controlling display of folder icons, comprising the steps of:
finding a present folder generated last in a file storage device in response to application of a folder display command;
controlling a display unit in such a manner that an icon of the found present folder is displayed on a display screen;
finding a past folder, which was generated before the found present folder, in the file storage device;
generating a future folder in response to finding of the present folder; and
controlling the display unit in such a manner that an icon of the found past folder and an icon of the future folder are displayed so as to bracket the icon of the present folder on opposite sides thereof.

8. A program of an apparatus for controlling display of folder icons, said program causing the apparatus to:
find a present folder generated last in a file storage device in response to application of a folder display command;
control a display unit in such a manner that an icon of the found present folder is displayed on a display screen;
find a past folder, which was generated before the found present folder, in the file storage device;
generate a future folder in response to finding of the present folder; and
control the display unit in such a manner that an icon of the found past folder and an icon of the future folder are displayed so as to bracket the icon of the present folder on opposite sides thereof.
